(19) United States
(12) Patent Application Publication
(10) Pub. No.: US 2017/0161711 A1
(43) Pub. Date: Jun. 8, 2017

(54) CHECKOUT SYSTEM AND METHOD FOR CHECKING-OUT PRODUCTS

(71) Applicant: MasterCard Asia/Pacific Pte. Ltd., Singapore (SG)

(72) Inventors: Yong How CHIN, Singapore (SG); Jiaming LI, Singapore (SG); Hao TANG, Singapore (SG)

(21) Appl. No.: 15/355,677

(22) Filed: Nov. 18, 2016

(30) Foreign Application Priority Data
Dec. 4, 2015 (SG) 10201510000T

(51) Int. Cl. G06Q 20/20; G06K 7/10

(52) U.S. Cl. CPC G06Q 20/208; G06K 7/10415

(57) ABSTRACT

A checkout system and method for checking-out products is provided. The checkout system comprising at least one scanner configured to identify one or more products to be checked-out; a weight sensor configured to determine a total weight of the one or more products; and a point-of-sale (POS) terminal in communication with the at least one scanner and the weight sensor, the POS terminal configured to: (i) determine a total reference weight by retrieving weights of the one or more identified products from a database; (ii) compare the total reference weight with the total weight of the one or more products determined by the weight sensor; and (iii) verify the identification of the one or more products by the at least one scanner based on the comparison of the total weight with the total reference weight.

### CROSS-REFERENCE TO RELATED APPLICATION

This application is a U.S. National Stage filing under 35 U.S.C. §119, based on and claiming benefit of and priority to SG Patent Application No. 10201510000T filed Dec. 4, 2015.

### FIELD OF INVENTION

The present disclosure relates to a checkout system and method for checking-out products.

### BACKGROUND

Currently, some retailers, e.g. supermarkets, use self-checkout counters with barcode scanners to facilitate payment and reduce queues at cashiers. Even though self-checkout counters may have reduced such queues, the use of barcode scanners during payment at these self-checkout counters has certain drawbacks. For example, the barcode and the scanner have to be in close proximity in order for the scanner to read the barcode. The barcode also has to be in the line of sight of the scanner in order to read the barcode.

In particular, to read the barcodes, each product has to be removed from the supermarket basket or trolley and individually scanned. This is a relatively time-consuming process.

Another problem arises when the barcode is not properly printed on the product or when the product is shrink-wrapped or laminated after the barcode is imprinted on the product. This causes the barcode to be unreadable by the scanner. Barcodes are also easily damaged as they have to be exposed on the exterior of the product in order for the scanner to achieve line of sight with the barcode. Security may also be an issue as barcodes can be easily forged and replicated with relatively minimal effort.

A need therefore exists to provide a checkout system and method for checking-out products.

### SUMMARY

According to a first aspect, there is provided a checkout system comprising at least one scanner configured to identify one or more products to be checked-out; a weight sensor configured to determine a total weight of the one or more products; and a point-of-sale (POS) terminal in communication with the at least one scanner and the weight sensor, the POS terminal configured to: (i) determine a total reference weight by retrieving weights of the one or more identified products from a database; (ii) compare the total reference weight with the total weight of the one or more products determined by the weight sensor; and (iii) verify the identification of the one or more products by the at least one scanner based on the comparison of the total weight with the total reference weight.

In an embodiment, the POS terminal may be further configured to obtain a weight of a container for holding the one or more products.

In an embodiment, the weight sensor may be further configured to determine a combined weight of the container and the one or more products placed therein such that the total weight of the one or more products is determined based on a difference between the combined weight and the weight of the container.

In an embodiment, the container may have a tag attached thereon and the at least one scanner may comprise a tag reader configured to read data from the tag, the data comprising the weight of the container.

In an embodiment, the tag may comprise a barcode and the tag reader may comprise a barcode reader configured to read the data encoded on the barcode to determine the weight of a container.

In an embodiment, the tag may comprise a RFID tag and the tag reader may comprise a RFID reader configured to read the data encoded on a signal from the RFID tag to determine the weight of a container.

In an embodiment, each of the one or more products may have a RFID tag attached thereon and the at least one scanner may comprise a RFID reader configured to read product identifier data encoded on a signal from the RFID tags to identify each of the one or more products.

In an embodiment, the weight sensor may comprise a platform having dimensions to receive the container in its entirety.

In an embodiment, one of the plurality of scanners may be disposed at one side of the platform and another of the plurality of scanners may be disposed at another side of the platform.

In an embodiment, the POS terminal may be further configured to (i) retrieve a list of identified products from each of the plurality of scanners; (ii) verify the identification of the one or more products by each of the plurality of scanners based on a comparison of the lists.

In an embodiment, the POS terminal may be further configured to retrieve a price of each of the one or more products from the database after verifying the identification of the one or more products.

In an embodiment, the POS terminal may be configured to initiate checkout of the one or more products on a condition that the comparison of total weights results in a difference that is less than a pre-determined amount.

In an embodiment, the pre-determined amount may be based on at least one of: the identity of the container, the identity of the products, the quantity of the products.

According to a second aspect, there is provided a method of checking-out one or more products, the method comprising: identifying the one or more products to be checked-out using at least one scanner; determining a total weight of the one or more products using a weight sensor; determining, using a point-of-sale (POS) terminal that is in communication with the at least one scanner and the weight sensor, a total reference weight by retrieving weights of the one or more identified products from a database that is in communication with the POS terminal; comparing, using the POS terminal, the total reference weight with the total weight of the one or more products determined by the weight sensor; and verifying, using the POS terminal, the identification of the one or more products by the at least one scanner based on the comparison of the total weight with the total reference weight.

In an embodiment, the method may further comprise the step of obtaining a weight of a container for holding the one or more products using the POS terminal.

In an embodiment, the method may further comprise the step of determining, using the weight sensor, a combined weight of the container and the one or more products placed therein such that the total weight of the one or more products is determined based on a difference between the combined weight and the weight of the container.

In an embodiment, the container may have a tag attached thereon and the at least one scanner comprises a tag reader, and wherein the method further comprises the step of reading data from the tag using the tag reader, the data comprising the weight of the container.

In an embodiment, each of the one or more products may have a RFID tag attached thereon and the at least one scanner may comprise a RFID reader, and wherein the method may further comprise the step of reading product identifier data encoded on a signal from the RFID tags to identify each of the one or more products.

In an embodiment, the method may further comprise the steps of: retrieving a list of identified products from each of a plurality of scanners; and verifying the identification of the one or more products by each of the plurality of scanners based on a comparison of the lists.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a schematic diagram of a checkout system according to an example embodiment.

FIG. 2 shows a flow chart illustrating a method for checking out products according to an example embodiment.

FIG. 3 shows a schematic diagram of a computer system that may be used to realize a Point-of-Sale (POS) terminal of the checkout system.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “identifying”, “authorizing”, “verifying” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

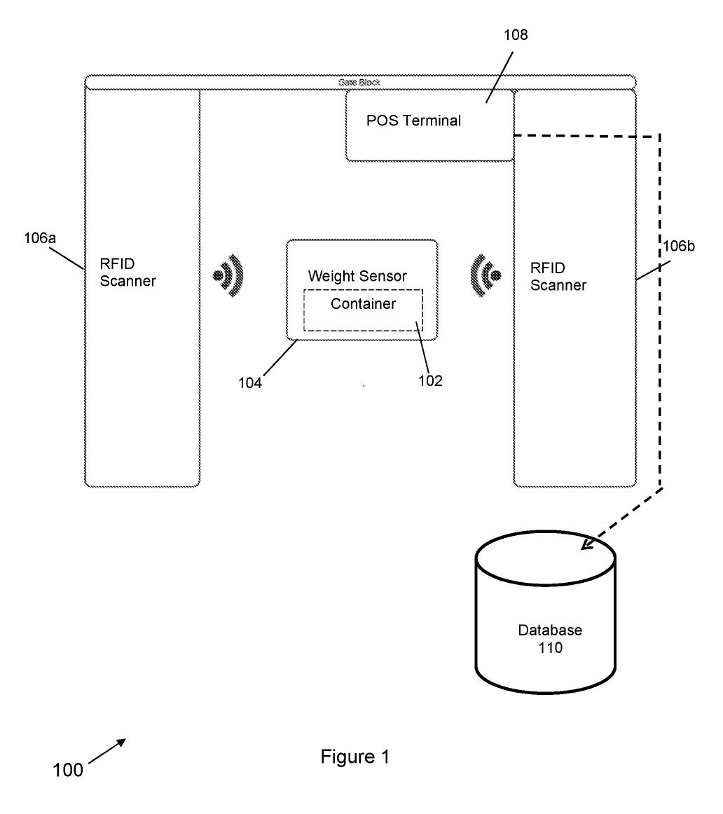

FIG. 1 shows a schematic diagram of a checkout system for facilitating payment of products according to an example embodiment. The system comprises at least one scanner (two are shown in FIG. 1—106a/106b), a weight sensor 104 and a Point-of-Sale (POS) terminal 108. After a consumer has finished his shopping and is ready to checkout and pay for his purchases, he places a container 102 onto the weight sensor 104.

The weight sensor 104 is configured to determine a total weight of the one or more products in the container 102. The weight sensor 104 can have a platform having dimensions to receive the container 102 in its entirety. Alternatively, the weight sensor 104 may comprise or be coupled to a support structure which is able to receive a hanging container or other receptacle (such as a bag) 102. The container 102 can be a basket, trolley or cart that is currently used in retail outlets such as supermarkets. The container 102 can also be any container or receptacle that is able to hold products to be purchased or checked-out, such as a box or a crate.

Each of the products may have a tag, such as a RFID tag, attached thereon. In the case of RFID tags, each tag may be capable of transmitting a signal that has product identifier data encoded therein. The at least one of the scanners 106a/106b may comprise a RFID reader that is configured to read the product identifier data encoded in the signal from the RFID tag. The product identifier data can comprise the price of the product and the weight of the product, or a product code or other identifier which can be used by the POS terminal 108 to query a database which stores product prices and weights, and other product information. One of the plurality of scanners 106a/106b can be disposed at one side of the platform and another can be disposed at another side of the platform. For example, as shown in FIG. 1, the scanners 106a/106b are disposed opposite to each other. In other embodiments, there may be more than two scanners that are disposed around the perimeter of the platform.

When the container 102 is placed on the weight sensor 104, the weight sensor 104 is configured to transmit an initialization signal to each of the scanners 106a/106b. Upon receipt of the initialization signal, each of the scanners 106a/106b is configured to identify one or more products in the container 102 to be checked-out by reading the tag placed on each product. Each of the scanners 106a/106b and the weight sensor 104 are communicatively coupled to the POS terminal 108. After each of the scanners 106a/106b identifies the one or more products in the container 102, the identity of the one or more products can be transmitted to the POS terminal 108.

The POS terminal 108 is configured to determine a total reference weight by retrieving weights of the one or more identified products from a database 110. The weight sensor 104 transmits the total weight of the one or more products in the container 102 to the POS terminal 108. The POS terminal 108 is configured to compare the total reference weight with the total weight of the one or more products determined by the weight sensor 104. Based on the comparison, the POS terminal 108 is capable of verifying the identification of the one or more products by the at least one scanner 106a/106b based on the comparison.

For example, a consumer wishes to purchase five products. He places these five products in the container 102. Each of the five products has a RFID tag attached thereon, and each RFID tag is capable of transmitting a signal that contains or represents the identity of the product (i.e. product identification data). During check-out, the consumer places the container 102 (with the five products) on the weight sensor 104. The scanners 106a/106b detect the five products in the container 102 and transmit the identity of the five products to the POS terminal 108. The POS terminal 108 retrieves the total reference weight of the five identified products, e.g. 1.2 kilograms, from the database 110. At the same time, the weight sensor 104 determines the total weight of the five products (assuming 1.2 kilograms) and transmits this value to the POS terminal 108. The POS terminal then compares the reference weight of 1.2 kilograms with the total weight of the five products (assuming 1.2 kilograms) from the weight sensor 104. By determining that both weights are similar, the POS terminal 108 is able to verify that the five products are in the container 102. If the reference weight and actual weight of the products do not tally or differ by a pre-determined value, it may be an indication that the scanners 106a/106b have incorrectly detected the products in the container 102.

There may be a number of reasons for the reference weight and actual weight of the products not tallying or differing by a pre-determined value. For example, the container 102 may not be properly positioned on the weight sensor 104 or the scanners 106a/106b do not detect all the products in the container 102. In the case of the former, the POS terminal 108 may display a message instructing the consumer to re-position the container 102 on the weight sensor 104. In the case of the latter, the POS terminal 108 may display a message instructing the consumer to pass the products individually through one of the scanners 106a or 106b for detection. Alternatively, additional scanners (i.e. in addition to scanners 106a/106b) can be used to increase the accuracy of detection of the products. For example, if one scanner does not detect a particular product, the other scanners may detect that product. A merged list of items can be generated from the individual scanner measurements and duplicate items can be ignored. If the total weight of the items in the merged list substantially matches the total weight at the weight sensor 104, check-out can proceed.

There can be a buffer for the weight comparisons to take into account variances in the actual weight of each product and/or variances in the actual weight of a container 102. For example, a product may not have a consistent weight due to variances in the weight of its packaging. Accordingly, in an embodiment, the POS terminal 108 may be configured to initiate checkout of the one or more products on a condition that the comparison of total weights results in a difference that is less than a pre-determined amount (i.e. the buffer amount). That is, the difference in weight between the total weight of the products in the container 102 and the total reference weight of the products is less than the pre-determined amount. The pre-determined amount may be set based on at least one of the following: (i) the identity of the container 102, (ii) the identity of the products and (iii) the quantity of the products. For example, if the container 102 is a trolley, the pre-determined amount may be set higher than if the container 102 is a basket as the weight of a trolley is typically larger and therefore a higher variance may be expected. If the products in the container 102 are generally heavier (e.g. packets of rice), the pre-determined amount may be set higher than if the products in the container 102 are relatively lighter (e.g. snacks). If the number of products in the container 102 is relatively high (e.g. twenty products), the pre-determined amount may be set higher than if the products in the container 102 are relatively low (e.g. one or two products).

In an implementation, the container 102 has a tag attached thereon and the at least one scanner 106a/106b may have a tag reader that is configured to read data from the tag. The data may comprise, at least, a weight of the container 102. The tag may be a barcode and the tag reader may be a barcode reader to read the data encoded in the tag to determine the weight of the container 102. The tag may also be a RFID tag and the tag reader may be a RFID reader to read the data encoded on a signal from the RFID tag to determine the weight of the container 102. In this manner, the actual weight of the container 102 can be obtained when necessary.

In an implementation, the POS terminal 108 is configured to obtain or retrieve a weight of the container 102 for holding the one or more products. For example, the weight of the container 102 may be obtained via weight data received from the tag attached on the container 102. The weight sensor 104 is configured to determine a combined weight of the container 102 and the one or more products placed therein such that the total weight of the one or more products is determined based on a difference between the combined weight and the weight of the container 102. Continuing from the example above, the weight sensor 104 determines that the combined weight of the five products and the container 102 is 1.5 kilograms. The weight sensor 104 transmits this combined weight data (“1.5 kilograms”) to the POS terminal 108. One of the scanners 106a/106b reads the tag on the container 102 to retrieve the weight data. In this manner, the POS terminal 108 is able to determine that the actual weight of the container 102 (e.g. 0.3 kilograms). The POS terminal 108 can determine the difference between the combined weight (1.5 kilograms) and the weight of the container 102 (0.3 kilograms) to determine the total weight of the one or more products (1.2 kilograms) in the container 102. The total weight of the one or more products in the container 102 is compared with the total reference weight of the products in order to verify the identification of the products by the scanners 106a/106b.

Alternatively, the consumer can use the container 102 to hold the products that he wishes to purchase. During checkout, he takes all the items out of the container 102 and places them on the weight sensor 104. In this manner, the weight sensor 104 is configured to directly determine a total weight of the one of more products. In this manner, the weight of the container 102 does not need to be known.

Turning back to FIG. 1, the POS terminal 108 may be further configured to retrieve a list of identified products from each of the plurality of scanners 106a/106b and verify the identification of the one or more products by each of the plurality of scanners 106a/106b based on a comparison of the lists. If there is a difference in the lists of identified products, it may be an indication that the scanners 106a/106b have incorrectly detected the products in the container 102. The POS terminal 108 may raise an alert and/or notify appropriate personnel for assistance. For example, if scanner 106a identifies five products in the container 102 while scanner 106b identifies four products in the container 102, it may be an indication that one of the scanners 106a/106b has incorrectly detected the products in the container 102 as there is a discrepancy in the number of products. As a further example, if scanner 106a identifies three products (“A”, “B” and “C”) in the container 102 while scanner 106b also identifies three products (“A”, “B” and “D”) in the container 102, it may be an indication that one of the scanners 106a/106b has incorrectly detected the products in the container 102 as there is a discrepancy in the identity of the products (“C” and “D”).

After the identification of one or more of the products has been verified, the POS terminal 108 is further configured to retrieve a price of each of the one or more products from the database 110 (or another database). Thereafter, the consumer can proceed to pay for his purchase at the POS terminal 108 using his payment card. For example, the POS terminal 108 may be coupled to a card reader or contactless reader and configured to read the consumer's payment card. Alternatively, a cloud-based payment can be used wherein the POS terminal 108 displays a Quick Response (QR) code and the consumer may pay for his purchase by scanning the QR code using a mobile telecommunication device, for example a mobile telephone.

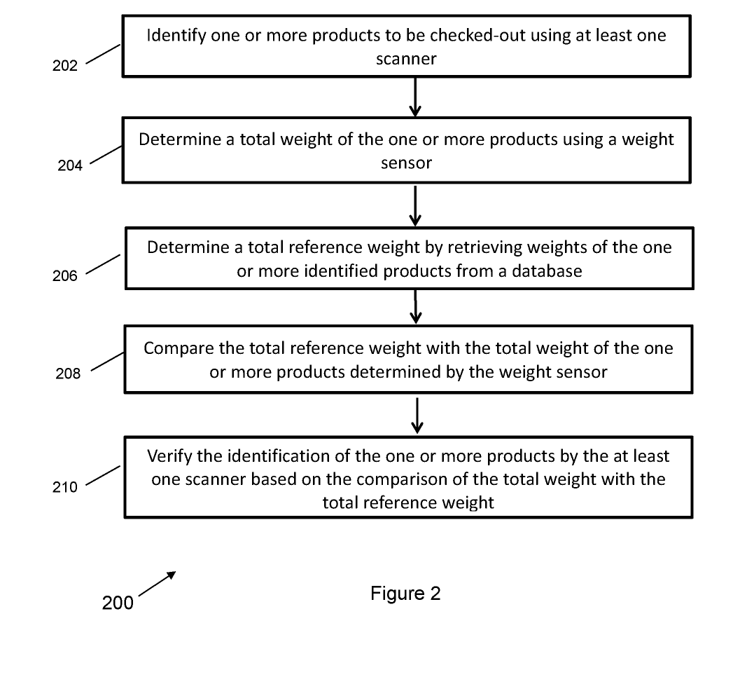

FIG. 2 shows a flow chart illustrating a method 200 for checking out one or more products according to an example embodiment. The method comprises the following steps. Step 202 involves identifying the one or more products to be checked-out using at least one scanner. Step 204 involves determining a total weight of the one or more products using a weight sensor. Step 206 involves determining, using a point-of-sale (POS) terminal that is in communication with the at least one scanner and the weight sensor, a total reference weight by retrieving weights of the one or more identified products from a database that is in communication with the POS terminal. Step 208 involves comparing, using the POS terminal, the total reference weight with the total weight of the one or more products determined by the weight sensor. Step 210 involves verifying, using the POS terminal, the identification of the one or more products by the at least one scanner based on the comparison of the total weight with the total reference weight.

The method may further comprise the step of obtaining a weight of a container for holding the one or more products using the POS terminal.

The method may further comprise the step of determining, using the weight sensor, a combined weight of the container and the one or more products placed therein such that the total weight of the one or more products is determined based on a difference between the combined weight and the weight of the container. The container may have a tag attached thereon and the at least one scanner may comprise a tag reader.

The method may further comprise the step of reading data from the tag using the tag reader. The data may comprise, at least, the weight of the container.

Each of the one or more products may have a RFID tag attached thereon and the at least one scanner may comprise a RFID reader. The method may further comprise the step of reading product identifier data encoded on a signal from the RFID tags to identify each of the one or more products.

The method may further comprise the steps of: retrieving a list of identified products from each of a plurality of scanners; and verifying the identification of the one or more products by each of the plurality of scanners based on a comparison of the lists.

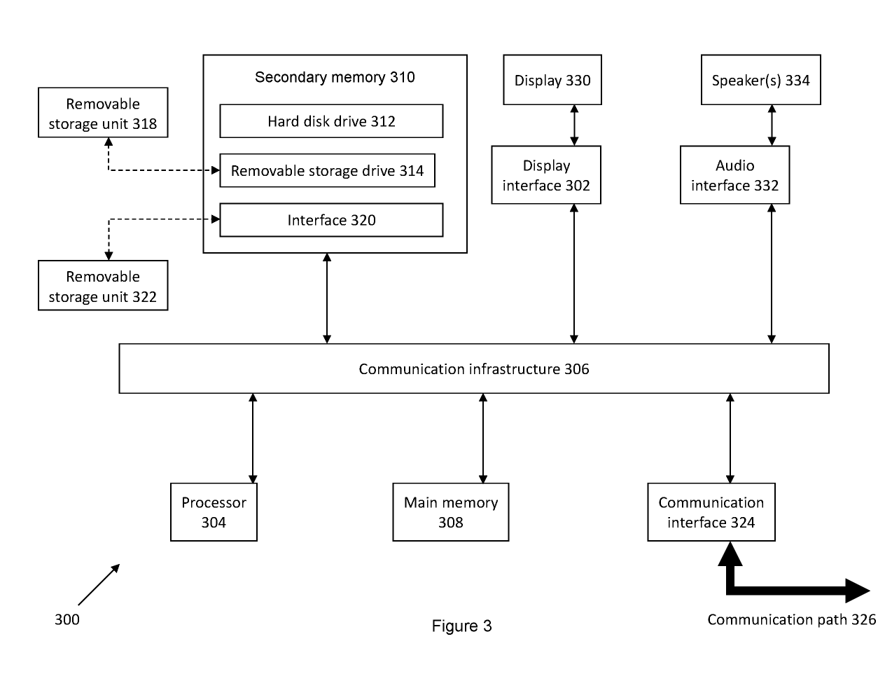

FIG. 3 depicts an exemplary computing device 300, hereinafter interchangeably referred to as a computer system 300, where one or more such computing devices 300 may be used to (at least partially) realize the POS terminal 108. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a hard disk drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage unit 318 in a well-known manner. The removable storage unit 318 may include magnetic tape, optical disk, non-volatile memory storage medium, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 320 which allow software and data to be transferred from the removable storage unit 322 to the computer system 300.

The computing device 300 also includes at least one communication interface 324. The communication interface 324 allows software and data to be transferred between computing device 300 and external devices via a communication path 626. In various embodiments, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. Computer readable storage media refers to any non-transitory tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the hard disk drive 312, or the interface 320. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

The use of a weight sensor, POS terminal, RFID tags and scanners for checking-out products as described herein may result in shorter queues at cashiers and self-checkout counters. In contrast with current barcode scanners at self-checkout counters, RFID technology does not require line-of-sight to detect the RFID tags on the products. RFID tags can be attached to the exterior or interior of products and RFID scanners are still able to read the tags. In the system as described herein, the entire supermarket basket or trolley can be placed onto the weight sensor and the consumer can pay for his purchase at the POS terminal after verification and the total price of the products is calculated. This can significantly reduce the checkout time as products need not be individually removed from a supermarket basket or trolley and scanned.

Further, RFID scanners have a high read-rate and have a longer range of up to 100 metres to detect RFID tags. Thus, products can be scanned easily and the calculated total price of the products can be readily shown on the POS terminal. Therefore, payment of the products at self-checkout counters can be quickly carried out and queues at such counters can be significantly reduced. Further, RFID scanners are also able to scan multiple RFID tags together, thereby reducing the amount of time required to scan each tag individually.

However, there is a possibility that the RFID scanners inaccurately detect or identify the items being checked-out. Accordingly, embodiments of the invention provide mechanisms and methods to improve detection/identification accuracy based on a weight of the products to be checked-out and/or the identity of items detected by each RFID scanner.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A checkout system comprising:
at least one scanner configured to identify one or more products to be checked-out;
a weight sensor configured to determine a total weight of the one or more products; and
a point-of-sale (POS) terminal in communication with the at least one scanner and the weight sensor, the POS terminal configured to:
(i) determine a total reference weight by retrieving weights of the one or more identified products from a database;
(ii) compare the total reference weight with the total weight of the one or more products determined by the weight sensor; and
(iii) verify the identification of the one or more products by the at least one scanner based on the comparison of the total weight with the total reference weight.

2. The checkout system as claimed in claim 1, wherein the POS terminal is further configured to obtain a weight of a container for holding the one or more products.

3. The checkout system as claimed in claim 2, wherein the weight sensor is further configured to determine a combined weight of the container and the one or more products placed therein such that the total weight of the one or more products is determined based on a difference between the combined weight and the weight of the container.

4. The checkout system as claimed in claim 2, wherein the container has a tag attached thereon and the at least one scanner comprises a tag reader configured to read data from the tag, the data comprising the weight of the container.

5. The checkout system as claimed in claim 4, wherein the tag comprises a barcode and the tag reader comprises a barcode reader configured to read the data encoded on the barcode to determine the weight of a container.

6. The checkout system as claimed in claim 4, wherein the tag comprises a RFID tag and the tag reader comprises a RFID reader configured to read the data encoded on a signal from the RFID tag to determine the weight of a container.

7. The checkout system as claimed in claim 1, wherein each of the one or more products has a RFID tag attached thereon and the at least one scanner comprises a RFID reader configured to read product identifier data encoded on a signal from the RFID tags to identify each of the one or more products.

8. The checkout system as claimed in claim 1, wherein the weight sensor comprises a platform having dimensions to receive the container in its entirety.

9. The checkout system as claimed in claim 8, comprising a plurality of scanners, wherein one of the plurality of scanners is disposed at one side of the platform and another of the plurality of scanners is disposed at another side of the platform.

10. The checkout system as claimed in claim 9, wherein the POS terminal is further configured to (i) retrieve a list of identified products from each of the plurality of scanners; (ii) verify the identification of the one or more products by each of the plurality of scanners based on a comparison of the lists.

11. The checkout system as claimed in claim 1, wherein the POS terminal is further configured to retrieve a price of each of the one or more products from the database after verifying the identification of the one or more products.

12. The checkout system as claimed in claim 1, wherein the POS terminal is configured to initiate checkout of the one or more products on a condition that the comparison of total weights results in a difference that is less than a pre-determined amount.

13. The checkout system as claimed in claim 12, wherein the pre-determined amount is based on at least one of: the identity of the container, the identity of the products, the quantity of the products.

14. A method of checking-out one or more products, the method comprising:
identifying the one or more products to be checked-out using at least one scanner;
determining a total weight of the one or more products using a weight sensor;
determining, using a point-of-sale (POS) terminal that is in communication with the at least one scanner and the weight sensor, a total reference weight by retrieving weights of the one or more identified products from a database that is in communication with the POS terminal;
comparing, using the POS terminal, the total reference weight with the total weight of the one or more products determined by the weight sensor; and
verifying, using the POS terminal, the identification of the one or more products by the at least one scanner based on the comparison of the total weight with the total reference weight.

15. The method as claimed in claim 14, further comprising the step of obtaining a weight of a container for holding the one or more products using the POS terminal.

16. The method as claimed in claim 15, further comprising the step of determining, using the weight sensor, a combined weight of the container and the one or more products placed therein such that the total weight of the one or more products is determined based on a difference between the combined weight and the weight of the container.

17. The method as claimed in claim 15, wherein the container has a tag attached thereon and the at least one scanner comprises a tag reader, and wherein the method further comprises the step of reading data from the tag using the tag reader, the data comprising the weight of the container.

18. The method as claimed in claim 14, wherein each of the one or more products has a RFID tag attached thereon and the at least one scanner comprises a RFID reader, and wherein the method further comprises the step of reading product identifier data encoded on a signal from the RFID tags to identify each of the one or more products.

19. The method as claimed in claim 14, further comprising the steps of:
retrieving a list of identified products from each of a plurality of scanners; and
verifying the identification of the one or more products by each of the plurality of scanners based on a comparison of the lists.
